(19) United States
(12) Patent Application Publication
(10) Pub. No.: US 2005/0129370 A1
(43) Pub. Date: Jun. 16, 2005

(54) Ferrule for connecting optical fibers

(76) Inventors: Yves Stricot, Villepreux (FR); El Mostafa Zindine, Le Mans (FR); Alain Flers, La Ferte Bernard (FR); Bogdan Rosinski, Brest (FR)

Correspondence Address: HARRINGTON & SMITH, LLP, 4 RESEARCH DRIVE, SHELTON, CT, 06484-6212, US

(21) Appl. No.: 10/504,951

(22) PCT Filed: Feb. 19, 2003
(86) PCT No.: PCT/EP03/50021

(30) Foreign Application Priority Data
Feb. 21, 2002 (FR) 0202247

(51) Int. Cl. G02B 6/36

(52) U.S. Cl. 385/89

(57) ABSTRACT

The invention concerns an integrated intermediate ferrule comprising an optical port and optoelectronic circuits functionally interposed between the optical port and an electric port. To avoid having to place a reflecting mirror causing optical losses, the integrated circuit for detection and optoelectronic conversion is arranged perpendicular to a rectilinear path of the light signal in the ferrule. Such an arrangement eliminates the need for a mirror and makes it easy to obtain accurate setting of the alignment of the optical port and the optoelectronic conversion circuits and finally provides efficient cooling of said optoelectronic conversion circuits.

### BACKGROUND OF THE INVENTION

1. Field of the Invention

An object of the present invention is a connection ferrule for optical fibers. It is designed to simplify the use of optical fibers which are an item of increasing utility.

An optical fiber is used essentially as a means to convey information in the form of light signals that are normally digitized. This means of transportation has the advantage of efficiently resisting noise, especially electromagnetic noise, and furthermore enabling very high data bit rates. However, since processing in present-day computer devices is of the electronic type, it is important to carry out an optoelectronic conversion of the light signals to be processed at input and output of the optical fiber. Various solutions have been devised for these problems of conversion.

2. Description of the Prior Art

Certain solutions have entailed the idea of making harnesses. In these harnesses, an optical fiber or a bundle of optical fibers is provided, fixedly at one of its two ends (or at least at one of its ends), with an optoelectronic conversion device. In this case, the optical fiber delivers electrical signals or electronic signals at one or both ends while it can deliver optical signals at another end. The drawback of this type of solution is, firstly, the cost generated by this integration of means. Secondly, the ease with which the fiber can be handled is thereby greatly reduced. Indeed, it will easily be understood that the length of the fiber cannot be adjusted as easily as desired, especially if it is provided on either side with electronic conversion circuits crimped to the ends of the fibers. In this case, it is not at all possible to lengthen or shorten the fiber. All that can be done is to exchange it for another differently sized harness, which however will also be a high-cost harness. Besides, the presence of the electronic conversion circuit leads to the making of a joining piece at the end of the optical fiber. The bulkiness of this joining piece is inconvenient if the fiber has to be threaded into narrow holes to conduct the signals from one place to another.

In other solutions, especially disclosed in the document WO 00/55665, an intermediate ferrule has been devised. This ferrule is designed to enable optical connection and is furthermore provided with integrated optoelectronic conversion means. However, owing to the chosen technique of transmission and the mechanical architecture used to make the device, an optical reflection mirror has to be prepared between the exit of the optical fibers and an optoelectronic detector or an optoelectronic emitter responsible for making the conversion. Mirror-based approaches of this kind can also be found in the following documents: U.S. Pat. No. 5,168,537, U.S. Pat. No. 6,132,107, and U.S. Pat. No. 6,161,965. The presence of such mirrors however raises optical and technological problems that impair the efficiency of the optoelectronic conversion undertaken. Indeed, these mirrors imply a specific manufacturing technology, need to be aligned and may be the cause of optical transmission losses.

At this stage, we are therefore either faced with solutions in which a bundle is present, as described for example in the document U.S. Pat. No. 5,416,872, or obliged to resolve the problems of reflection referred to here above.

In the invention, it is planned to overcome these drawbacks by proposing a ferrule capable of receiving detachable ends of optical fibers (normally presented in a standardized joining piece) and capable of also carrying out optoelectronic conversion, without furthermore having to deflect the light rays coming from or sent to the optical fibers. The receiving of detachable joining pieces in optical port averts the problem of the bundles. It is enough to have a set of optical fiber sections with variable sizes. On the one hand, the joining pieces cost little to make, and on the other hand their compactness allows them to be threaded anywhere. The deflection of the light rays is prevented by placing the useful part of the optoelectronic conversion circuit so that it directly faces a rectilinear optical path coming from the optical port.

The ferrule of the invention then has the overall shape of a parallelepiped, of which one of the faces, containing the optical port, is used to receive the detachable ends of the optical fibers, while a face opposite to this receiving face bears an optoelectronic detection and/or emission circuit as well as a control circuit. Preferably, on a face contiguous to these two faces, the package of the ferrule bears contacts enabling the connection of this ferrule to an electronic circuit, especially a printed circuit.

Furthermore, given the difficulties of alignment during the positioning of the optoelectronic detection and/or emission circuit facing the optical paths thus made (and in which no optical correction is necessary in principle), a precise positioning is planned using a technique for the reflow soldering of solder beads. This technique has the advantage of providing for positioning with a precision of about one micrometer. Furthermore, by then preferably making the package of the ferrule out of plastic, a notable reduction in the cost of the conversion ferrule is achieved.

### SUMMARY OF THE INVENTION

An object of the invention therefore is a ferrule for the connection of optical fibers comprising an optical port on an input face to detachably receive one or more terminations of optical fibers, optoelectronic circuits for the conversion of optical signals into electrical signals and/or vice versa, placed on an output face opposite the input face and an electrical port providing connection to an electronic circuit, wherein the ferrule has an optical path leading firstly directly onto the optical port, and secondly directly onto a detection or emission part of the conversion circuits and wherein the electrical port is placed on a connection face contiguous to the input and output faces.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 is a view in perspective, seen from underneath, of a connection ferrule according to the invention;

FIG. 2 is a diagrammatic side view of the ferrule of FIG. 1;

FIG. 3 shows a part of the optical fiber connection ferrule of the invention, before the installation of the optoelectronic conversion circuits;

FIG. 4 is a diagrammatic view of the preferred mounting of an optoelectronic integrated circuit in the ferrule of the invention;

FIG. 5 shows dimensions of the ferrule of the invention and presents improvements of use;

FIG. 6 shows a particularly useful installation of a heat sink to cool the optoelectronic conversion circuits.

### MORE DETAILED DESCRIPTION

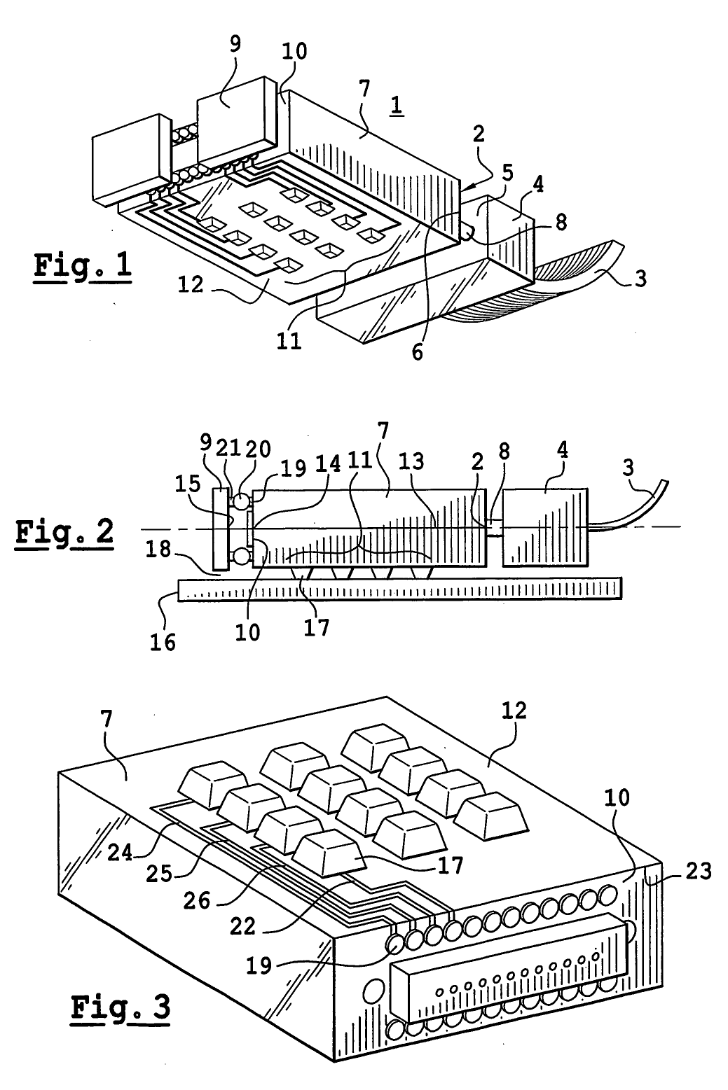

FIG. 1 shows ferrule 1 for connecting optical fibers according to the invention. This ferrule 1 has an optical port 2 to detachably receive one or more optical fiber terminations. The optical fibers received are, for example, optical fibers such as 3 provided at their ends with a joining piece 4 that is preferably standardized. The number of fibers 3 may preferably be an even number, with one fiber serving for transmission in one direction, and another for transmission in another direction. The fibers mounted in a flexible sheet may relate to any unspecified number of transmission channels, ideally but not solely, four to-and-fro transmission channels. The joining pieces 4 are used to obtain a preset distance between the different terminations of the optical fibers of a sheet.

The joining piece 4 thus has a face 5 designed to abut a face 6 of the ferrule 1. The face 6 is the one comprising the optical port 2. In order to provide for the precise positioning, to within about one micrometer, of the ends of the optical fibers 3 in the optical port 2, the joining piece 4 is provided with pins 8 that get engaged in reserved positions made to match in the face 6, also in a very precise manner. The pins 8 are used to guide the terminations in the optical port. A package 7 of the ferrule 1 is made of insulating material. Preferably, the package 7 is molded. Preferably it is made of plastic, for example PBT, LCP or polyimide which stands up well to temperature, or any other technical plastic material that stands up to cycles for mounting components by reflow soldering. In the example, the package 7 is furthermore metallized so as to carry electrical tracks.

The ferrule 1 also has optoelectronic circuits 9 for the conversion of optical signals into electrical signals and/or vice versa. In the invention, the optoelectronic conversion circuits 9, at least detection and/or emission circuits of these conversion circuits, are placed on a face 10 of the package 7 that is opposite the face 6 by which the optical fibers have been received. The package 1 has yet another electrical port 11 represented herein by a series of pads forming elevated features on one face 12 of the package 1. The face 12 is contiguous firstly to the face 10 and secondly to the face 2.

According to an essential characteristic of the invention, shown in FIG. 2, the optical signals coming from the optical fibers 3 travel through a preferably rectilinear optical path 13 inside the package 7. They travel between the optical port 2, and hence the immediate output of the fiber 3, and the conversion circuits 9 at which they produce a direct impact or from which they come out directly, in both cases without reflection. The optical path 13 is given shape, in the package 7 by a material that is solid, liquid or gaseous and transparent to light rays. To simplify the explanation, it may be assumed that the package 7 is thus provided with grooves 13 whose orientation is preferably parallel to the pins 8 and is therefore substantially perpendicular to an output face of the joining piece 4 of the optical fibers 3. These grooves 13 are aligned so that, at their other end 14, they are placed directly facing and perpendicular to a detection face 15 of the optoelectronic circuits 9. This mode of action makes it clear that it is possible to do without a reflection circuit whose drawbacks moreover are known.

Thus, in the event of the use of optical fibers supported in the package 7 and serving as an interface between the input face of the package and the output face of the package to convey optical signals between the optical port 2 and the optoelectronic components, the holding means constituted by the grooves 13 may be rectilinear. In the case of a use of optical waveguides directly made in the package 7, the waveguides replacing the interface fibers may be curved, recombined or separated as a function of a desired application.

To make the ferrules of FIGS. 1 and 2, several solutions are possible. These solutions must furthermore comply with certain constraints. As can be seen in FIG. 2, the optoelectronic detection or emission and signal-reshaping integrated circuit 9 is, on the whole, mounted edgewise, perpendicularly to a printed circuit 16 designed to come into contact with the electrical port 11. The elevation of the pads 17 so that they are in relief with respect to the electrical port 11 furthermore makes it possible to leave space for a blade of air curtain 18, or for any other material, between the integrated circuit 9 and printed circuit 16 so as to ensure installation and guarantee the reliability of the mounting of the component. As a variant, the contacts 17 of the electrical port may also be fixedly joined and electrically connected to a connector element, one counterpart element of which is fixedly joined to the printed circuit 16 receiving the ferrule.

For its electrical connection to the printed circuit 16, the integrated circuit 9 is connected to metallized pins 19 placed on the face 10 of the package 2. It is connected to them by solder beads such as 20. The solder beads 20 are furthermore connected to connection pins 21 of the integrated circuit 9 itself.

The technique of setting up an electrical connection of the integrated circuit 9 by solder beads is a technique known as the flip-chip technique, in which a reflow of the solder beads is produced. In practice, during manufacture, the integrated circuit 9 is placed horizontally above the package 7 after the positioning of the solder beads 20. In this phase, the package 7 is raised vertically with its face 10 on top. Then the entire piece is taken to a reflow temperature of over 260 degrees. Then the solder beads 20 achieve firstly the electrical soldering of the pins 19 to the pins 21. Secondly, through the surface tensions that develop in the solder, they provide for an exact positioning of these pins 21 relative to the pins 19. Consequently, if by construction of the integrated circuit 9, the pins 21 are positioned precisely relative to the detection or emission ports 15 of the electronic circuits 9, and furthermore the pins 19 are placed, by construction, precisely relative to the output hole 14 of the rectilinear path 13 in the package 7, then the positioning of the electronic circuit 9 is obtained quite naturally and with high precision, in practice with a precision of about one micrometer. We then have a configuration in which the alignment is perfect, with a well-mastered technology and hence a low-cost result. At the same time, the assembly could be done otherwise, for example by using a precise positioning machine.

FIG. 3 shows the making of electrical tracks 22 by which the pins 19 of the package can be connected to the pads 17 of the electrical port 11. While the package 7 is preferably made of plastic, the metallized tracks 22 may be obtained in different ways. For example, the totality of the package is metallized and the tracks 22 are etched thereon, on all its faces, by wet etching or by dry etching (by laser). As a variant, it is possible to carry out a selective etching of the surface of the package 7, at the position of the tracks 22, so as to chemically activate the material of the service of the package at the position of these tracks 7. Then the package is subjected to a chemical metallization, with the metal particles adhering to the zones that have been activated.

It is thus possible to make tracks 22 that spread out not only on one face 12 of the package containing the pads 17 but also on one or more other contiguous faces of the package. Furthermore, at the position where there is a change of face, the tracks show electrical continuity. If need be, the ridges 23 between two contiguous faces 10 and 12 may be rounded to foster the making of this electrical continuity. As can be seen in FIGS. 2 and 3, the electrical tracks may be of different lengths according to the remoteness of the pad 17 that they connect to the face 10.

In the invention, it is noted that the electronic circuit 9 must be powered electrically, must receive control or signaling signals, and must transmit signals to be electro-optically converted or that have been electro-optically converted. It will then be chosen to reserve tracks such as 24 and 25, which have the longest route in the package 7, for carrying electricity. Tracks 26 of intermediate length will be used for the transmission of the control or signaling signals, while the shortest tracks 22 will serve for the transmission of the signals detected or to be transmitted. In practice, the signals to be transmitted or the converted signals available on the track 22 are very rapidly variable signals. Their variation depends on the bit rate which may be equal to about several gigabits per second. The signals conveyed by the connections 26 are less rapidly variable, for example about one MHz, while the signals on the connections 24 and 25 are for their part direct current signals. The tracks 22 and 24 to 26 are preferably made on the external faces of the package 7.

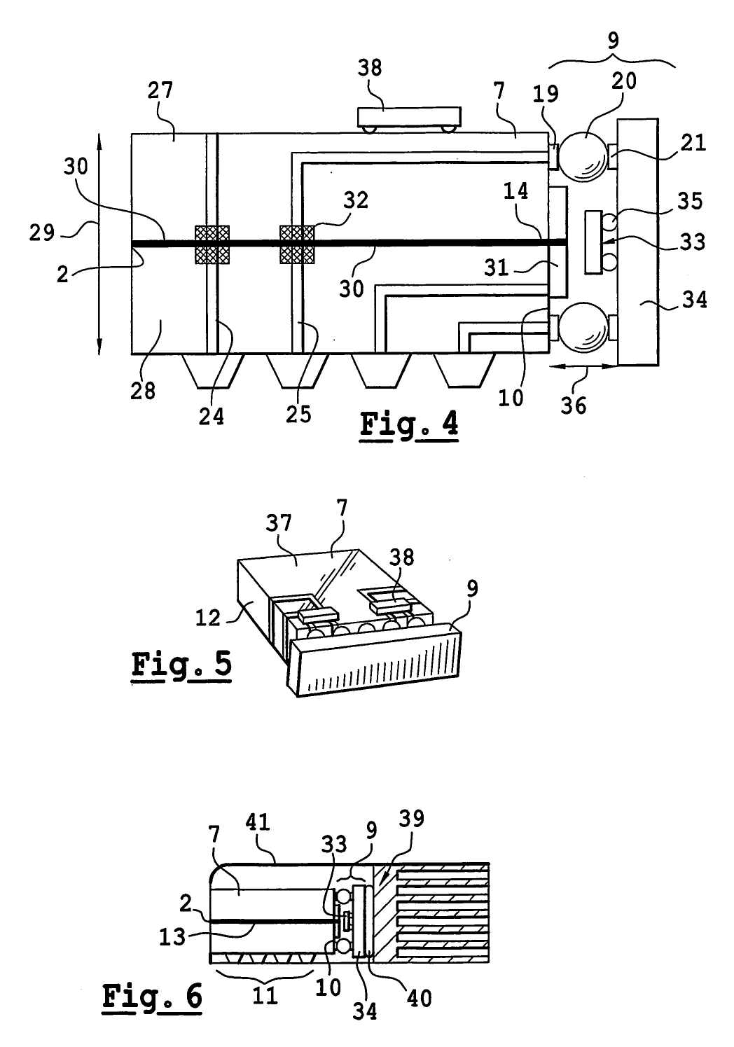

FIG. 4 is a diagrammatic sectional view of the package 7 as well as the electronic circuit 9. It furthermore shows that the package 7 is formed by two blocks 27 and 28 joined together. For example, the two blocks 27 and 28 are parallelepiped-shaped, like the package 7, and have a height, measured perpendicularly to the printed circuit 16, that is half the height 29 of the entire package 7. The two blocks 27 and 28 possess means to form rectilinear optical paths at the position 30 at which they meet. In one example, these means are formed by the presence of V-shaped or U-shaped grooves made in at least one of the two blocks 27 or 28, the other block being possibly devoid of grooves and being flat. If desired, these grooves can be used for the positioning of optical fiber sections therein or for the deposition therein of a polymer resin playing the role of an optical waveguide so as to make the package 7 transparent to light at their position. When optical fiber sections or polymer waveguides are thus placed in the meeting zone 30, a thrust feature 31 on the face 10 of the package 7 enables the ends of the sections to be polished without damage to the metallized tracks.

As a variant, the package is a unique single-piece unit. It is then pierced with rectilinear holes in which the optical fiber sections or waveguide are placed or not placed.

The mode of manufacture of the package 7 in two blocks 27 and 28 is preferred because it enables a simpler making of the rectilinear optical paths. The precision of the making of a groove is greater than the precision of the making of a hole, as the former can be far more rectilinear than the latter. Furthermore, the making of the package in two blocks permits the making of paths 13 in the form of a material molded in the grooves before the blocks are attached together.

Consequently, the metallized tracks such as 24 and 25 each made partly on each of the blocs are joined, after the two blocks 27 and 28 are attached to each other by electrical bridges such as 32. The electrical bridges are either simple solders, or used to positioning complementary circuits, especially electrical decoupling circuits, to prevent the transmission of parasitic electronic signals. The two blocks 27 and 28 are joined to each other by bonding or by ultrasonic soldering or by laser, without or without the presence of optical fibers.

If necessary, at the position of the port 2 and of the optical output 14, optical lenses may be placed. Or quite simply, the optical fiber sections placed in the holes or in the grooves have rounded shapes at their ends giving a similar lens effect.

FIG. 4 also shows that the detection or emission and conversion integrated circuit 9 can preferably be made in the form of two integrated circuits stacked one on the other. For example, the integrated circuit 9 has the detection (or emission) circuit proper 33. The circuit 33 is based on VCSEL type diodes. The circuit 9 also has an integrated analog-digital conversion integrated circuit 34. The integrated circuit 34 converts analog electrical signals produced by the detector 33 into digital electrical signals or vice versa if the circuit 33 is an emitter. Preferably, the integrated circuit 33 is connected, by pins not shown, to the integrated circuit 34 by the reflow of solder beads 35, of the same type as the solder beads 20 so as to ensure a precise positioning of this integrated circuit 33 relative to the integrated circuit 34. Since the integrated circuit 34 has itself being placed precisely by beads 20 relative to the output 14 of the package 7, the result obtained is that the circuit 33 is placed precisely relative to the package 7. Given the distances, the solder beads 35 will be far smaller than the solder beads 20 so that the integrated circuit 33 can find a place in a gap 36 made between the face 10 of the package 7 and the integrated circuit 34. Typically, the space between the surface 15 and the face 10 is 100 micrometers.

FIG. 5 shows the overall dimensions of the unit formed by the package 7 and the optoelectronic integrated circuit 9. In practice, a ferrule module according to the invention will have the following dimensions, plus or minus 10%: a length of 5 mm, a width of 7 mm and a height of 2 mm. It will be noted that this height of 2 mm is quite compatible with assembly on a printed circuit 16, and permits the attachment of several printed circuit boards 16 mounted edgewise and placed against one another. FIG. 5 also shows that it is possible to use an upper face 37 of the package 7, opposite the face 12 bearing the electrical port 11, to position other integrated circuits such as 38 in a position of interconnection between or on electrical linking tracks. The circuit 38 will preferably be a passive type circuit, mounted according to an SMC (surface-mounted component) type of technology.

FIG. 6 gives a diagrammatic view of the package 7 connected to an electronic circuit 9. The electronic circuit 9 has a flat conversion circuit 34 whose surface is substantially parallel to the output face 10 of the package 7. This construction then permits the positioning of a sink 39 placed flat against the back of the integrated circuit 34, for example by means of a thermal transmission bonder 40. Indeed, it can be estimated that an optoelectronic conversion circuit working at very high speed to ensure the bit rate transmitted by the optical fiber is an element that produces a substantial quantity of heat. The fact of having placed the integrated circuit 34 edgewise, perpendicularly to a printed circuit 16 (not shown) then makes it possible to place the sink 39 usefully with its thermal connector plate perpendicular to the printed circuit 16.

In a commercially distributed version, this set is placed in a holding case 41. The holding case 41 possesses, firstly, the optical port 2 and, secondly, the optical port 11, both being placed on faces that are perpendicular to the package 7.

It is possible to install a certain number of emitter/receiver pairs made in one or more integrated circuit such as 9 mounted on the face 10 and connect them to the pins such as 19.

The large number of pads such as 17 enables the package to be held on the circuit 16. If need be, some of them are not functional for making electrical links.

1. Ferrule for the connection of optical fibers comprising an optical port on an input face to detachably receive one or more terminations of optical fibers, optoelectronic circuits for the conversion of optical signals into electrical signals and/or vice versa, placed on an output face opposite the input face and an electrical port providing connection to an electronic circuit, characterized in that the ferrule has an optical path leading firstly directly onto the optical port, and secondly directly onto a detection or emission part of the conversion circuits and in that the electrical port is placed on a connection face contiguous to the input and output faces.

2. Ferrule according to claim 1, characterized in that the optical path is formed in a package comprising the input face provided with the optical port, the output face bearing at least one part of the optoelectronic circuits and the connection face comprising contacts of the electrical port.

3. Ferrule according to claim 1, characterized in that the optical path is rectilinear.

4. Ferrule according to claim 2, characterized in that the package comprises electrical tracks on its external faces to connect the optoelectronic circuit to the contacts of the electrical port.

5. Ferrule according to claim 2, characterized in that the optoelectronic circuit is connected to the tracks of the package by operations of reflow of solder beads.

6. Ferrule according to claim 2, characterized in that electrical tracks made in the package to connect the optoelectronic circuit to the contacts of the electrical port comprise first DC electrical power supply tracks and second tracks taking a route in the package that is shorter than the first tracks.

7. Ferrule according to claim 2, characterized in that the package is made out of two blocks joined by a common face, the region in which the blocks meet comprising optical paths, and electrical bridges being made for the continuity of the electrical tracks located in part on one block and in part on another block.

8. Ferrule according to claim 2, characterized in that the package is made of an insulating material, molded and metallized to carry electrical tracks.

9. Ferrule according to claim 1, characterized in that the optical path is formed by a solid material transparent to light rays.

10. Ferrule according to claim 1, characterized in that the contacts of the electrical port are formed by metallized pads.

11. Ferrule according to claim 1, characterized in that the optoelectronic circuit comprises a first integrated circuit for the conversion of electrical signals and a second integrated circuit for optical detection and/or emission, the second integrated circuit being mounted on and being connected with the first integrated circuit by operations of reflow of solder beads.

12. Ferrule according to claim 1, characterized in that the optical port comprises means to precisely guide optical terminations in the optical port.

13. Ferrule according to claim 1, comprising a sink characterized in that the optoelectronic circuit comprises a first integrated circuit for the conversion of electrical signals, this first integrated circuit being placed in contact with the sink.

14. Ferrule according to claim 1, characterized in that the optoelectronic circuit comprises a first integrated circuit for the conversion of electrical signals, this first integrated circuit being placed perpendicularly to a printed circuit receiving the ferrule.
